(19) United States
(12) Patent Application Publication
(10) Pub. No.: US 2013/0325516 A1
(43) Pub. Date: Dec. 5, 2013

(54) SYSTEM AND METHOD FOR GENERATING INSURANCE CONTRACT DOCUMENTS COMPLIANT WITH STATE INSURANCE REGULATIONS

(71) Applicants: Krishna Bheemanakatte, South Windsor, CT (US); Brian P. Cruess, Hebron, CT (US); Manuela Panno, Rocky Hill, CT (US); Kathie Read, Avon, CT (US); Peter Brin, South Windsor, CT (US)

(72) Inventors: Krishna Bheemanakatte, South Windsor, CT (US); Brian P. Cruess, Hebron, CT (US); Manuela Panno, Rocky Hill, CT (US); Kathie Read, Avon, CT (US); Peter Brin, South Windsor, CT (US)

(73) Assignee: Hartford Fire Insurance Company, Hartford, CT (US)

(21) Appl. No.: 13/489,453

(22) Filed: Jun. 5, 2012

(51) Int. Cl. G06Q 40/08

(52) U.S. Cl. 705/4

(57) ABSTRACT

Provided are systems and methods for generating state-specific insurance contract documents that are compliant with their respective state's insurance regulations. In particular, these systems and methods are provided in accordance with a simplified model for maintaining and creating insurance contract documents that are compliant with state insurance regulations. State-specific insurance contract documents are generated by combining baseline section template files and state-specific section template files in accordance with contract generation rules that are defined to create a state-specific insurance contract document that it compliant with its respective state's insurance regulations.

### FIELD OF INVENTION

The present invention relates generally to the maintenance and creation of contract documents, and more particularly, to the maintenance and creation of insurance contract documents that are compliant with state insurance regulations.

### BACKGROUND

The creation of complex contracts, such as insurance contract documents, can be very resource intensive and time consuming. Moreover, the creation of insurance is particularly complex because they must comply with state insurance regulations that may require particular contract language. The state department of insurance in the state where an insurance contract document is to be issued must approve the insurance contract document before it can be issued. For example, states often require that an insurance policy contract form be filed with and approved by the state's insurance department. Additionally, because an insurance company may use the same insurance contract document in various states, such a contract must comply with insurance regulations from these various states. Traditionally, insurance companies have drafted these types of insurance contract documents with conditional logic (e.g., if/then statements) to generate contract language that complies with the insurance regulations of each of the states where the contract may be issued.

However, the use of conditional logic in an insurance contract document creates a level of complexity that makes it difficult to amend or revise particular sections of the contract without creating unintended consequences in other sections of the same contract. This problem is particularly pronounced in insurance contract documents that contain conditional logic across hundreds of sections in the insurance contract document, because it is difficult to determine the impact that a change in one section may have on the remainder of the contract. Accordingly, when state insurance regulations change and insurance contract documents need to be revised accordingly, it is difficult to revise insurance contract documents employing conditional logic without inadvertently making changes to the insurance contract document that may render the insurance contract document non-compliant with applicable state insurance regulations.

### SUMMARY

In accordance with one aspect of the invention, provided is a system for generating state-specific insurance contract documents that are compliant with their respective state's insurance regulations. The system comprises a data storage device and at least one processor connected to the data storage device. The data storage device stores a database and a contract generation program. The database stores baseline section template files corresponding to more than one state and state-specific section template files corresponding to a single state. Each of the baseline section template files and state-specific section template files correspond to a specific section of an insurance contract document that is compliant with a corresponding state's insurance regulations. The processor is configured to execute the contract generation program stored on the data storage device to generate an insurance contract document for said specified state by defining a combination of baseline section template files and state-specific section template files that has previously been determined to comply with said specified state's insurance regulations.

In accordance with another aspect of the invention, provided is a computerized method for generating state-specific insurance contract documents that are compliant with their respective state's insurance regulations. The method is preferably executed by a contract generation program executing on a computer processor. In accordance with one embodiment, the method may include receiving information regarding an insurance product and a state for which an insurance contract document is to be generated. The method may also include identifying contract generation rules for generating state-specific insurance contract document for a requested insurance product and state that is compliant with the state's insurance regulations. The method may further include defining a combination of baseline section template files and state-specific section template files that has previously been determined to comply with the state's insurance regulations. The method may additionally include generating an insurance contract document in accordance with the defined combination of baseline section template files and state-specific section template files.

In accordance with yet another aspect of the invention, provided is a non-transitory, tangible computer-readable medium storing instructions adapted to be executed by a computer processor to perform the above-described method for generating state-specific insurance contract documents that are compliant with their respective state's insurance regulations.

In accordance with yet another aspect of the invention, provided is a computerized method for amending insurance contract documents and ensuring compliance with state insurance regulations. The method is preferably executed by a contract management program executing on a computer processor. In accordance with one embodiment, the method may include receiving a request to make a change to an insurance contract document. The method may also include analyzing the requested change to identify section template files that are affected by the requested change. The method may further include determining whether an affected section template file is a baseline section template file or a state-specific section template file. If the affected section template file is a state-specific section template file, the program determines whether the requested change is in a Statement of Variable Language for the insurance contract document or the requested change is approved by a corresponding state's Department of Insurance. If the requested change is in a Statement of Variable Language for the insurance contract document or is approved by the corresponding state's Department of Insurance, the state-specific section template file is updated to implement the requested change. However, if the requested change is not in a Statement of Variable Language for the insurance contract document and is not approved by the corresponding state's Department of Insurance, confirmation that the requested change has been approved by the corresponding state's Department of Insurance must be received before proceeding.

In accordance with yet another aspect of the invention, provided is another computerized method for amending insurance contract documents and ensuring compliance with state insurance regulations. The method is preferably executed by a contract management program executing on a computer processor. In accordance with one embodiment, the method may include receiving a request to make a change to an insurance contract document. The method may also include analyzing the requested change to identify section template files that are affected by the requested change. The method may further include determining whether an affected section template file is a baseline section template file or a state-specific section template file. If the affected section template file is a baseline section template file, the program determines the states whose contracts use the affected baseline section template file. The program further determines whether the requested change is included in a Statement of Variable Language for each of the states whose contracts use the affected baseline section template file. If the requested change is in a Statement of Variable Language for each of the states whose contracts use the affected baseline section template file, the affected baseline section template file is updated to implement the requested change. However, if the requested change is not in a Statement of Variable Language for each of the states whose contracts use the affected baseline section template file, the program determines whether the requested change is approved by a state's Department of Insurance. If the requested change is not approved by the state's Department of insurance, confirmation that the requested change has been approved by the state's Department of Insurance must be received before proceeding. If the requested change is approved by the state's Department of insurance, a state-specific section template file for the state is created by implementing the requested change.

### BRIEF DESCRIPTION OF THE FIGURES

The foregoing summary, as well as the following detailed description of the preferred embodiments, is better understood when read in conjunction with the appended drawings. For the purpose of illustrating the invention, there is shown in the drawings embodiments that are presently preferred, it being understood, however, that the invention is not limited to the specific embodiments disclosed. In the drawings:

FIG. 1; shows an illustration of the organization of an insurance contract document, according to an illustrative embodiment of the invention;

FIG. 2A is an example of a baseline section template file file;

FIG. 2B shows the contract language generated by the baseline section template file of FIG. 2A;

FIG. 3A is an example of a state-specific section template file file;

FIG. 3B shows the contract language generated by the state-specific section template file of FIG. 3A;

FIG. 4 shows an illustration of one aspect of the process of creating a state specific insurance contract document, according to an illustrative embodiment of the invention;

FIG. 5 is a block diagram of an insurance computer network, according to an illustrative embodiment of the invention

FIG. 6 is a block diagram of a computer system in the insurance computer network of FIG. 5, according to an illustrative embodiment of the invention

FIG. 7 is flow chart depicting a process for amending a section template file file, according to an illustrative embodiment of the invention;

FIG. 8 is a flowchart depicting a process for generating state-specific insurance contract documents that are compliant with their respective state's insurance regulations, according to an illustrative embodiment of the invention;

FIG. 9 shows a web-based graphical user interface associated with the process depicted in FIG. 8, according to an illustrative embodiment of the invention;

FIG. 10 shows a web-based graphical user interface associated with the process depicted in FIG. 8, according to an illustrative embodiment of the invention;

FIG. 11 shows a web-based graphical user interface associated with the process depicted in FIG. 8, according to an illustrative embodiment of the invention;

FIG. 12 shows a web-based graphical user interface associated with the process depicted in FIG. 8, according to an illustrative embodiment of the invention;

FIG. 13 shows a web-based graphical user interface associated with the process depicted in FIG. 8, according to an illustrative embodiment of the invention; and

FIG. 14 shows a web-based graphical user interface associated with the process depicted in FIG. 8, according to an illustrative embodiment of the invention.

### DETAILED DESCRIPTION

Before the various embodiments are described in further detail, it is to be understood that the invention is not limited to the particular embodiments described. It will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof. It is also to be understood that the terminology used is for the purpose of describing particular embodiments only, and is not intended to limit the scope of the claims of the present application.

In the drawings, like reference numerals refer to like features of the systems and methods of the present application. Accordingly, although certain descriptions may refer only to certain Figures and reference numerals, it should be understood that such descriptions might be equally applicable to like reference numerals in other Figures.

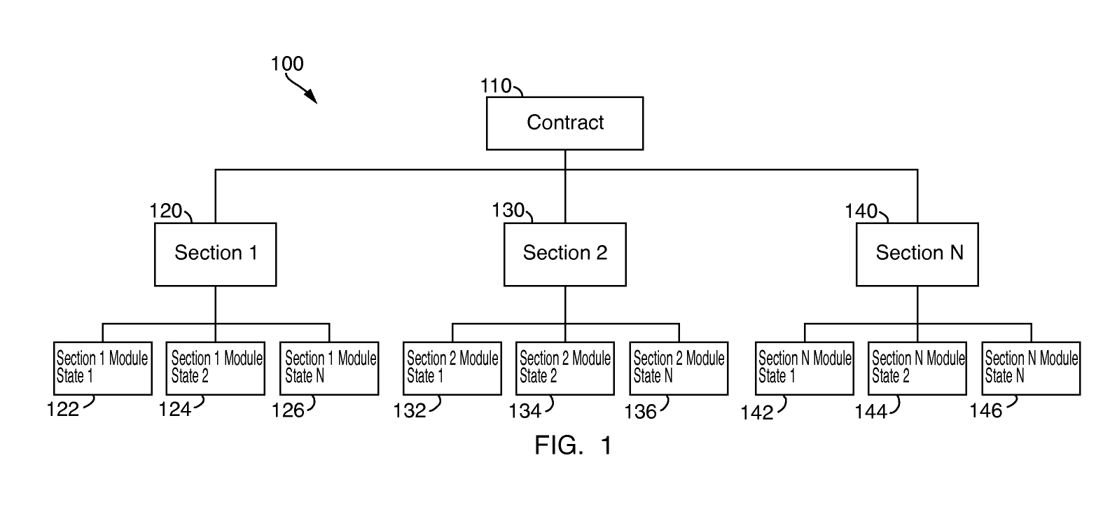

The present application is directed to systems and methods for generating state-specific insurance contract documents that are compliant with their respective state's insurance regulations. In particular, these systems and methods are provided in accordance with a simplified model for maintaining and creating insurance contract documents that are compliant with state insurance regulations. In accordance with the simplified model, a model contract organization 100 is preferably maintained across various state-specific versions of a given insurance contract document 110. Thus, the state-specific insurance contract document for one state will preferably have the same document organization and contract sections as the state-specific insurance contract document for another state. For example, as shown in FIG. 1, an exemplary model contract organization 100 comprises insurance contract document sections 1-N (120, 130. 140) for an insurance contract document 110.

Once the state-specific insurance contract documents are approved by their respective state's department of insurance, section template files 122-126, 132-136, 142-146 may be created for each of the sections 120, 122, 124 of the insurance contract document 110. A section template file is a data file that defines the contract language in a section of an insurance contract document that has been approved as compliant by the respective state's department of insurance. Accordingly, in order to prevent inadvertent and/or unapproved changes to provisions in an insurance contract document, the section template files are preferably read-only type files. As illustrated in FIG. 1, each of sections 1-N (120, 130. 140) of the model contract organization 100 will have corresponding section template files 122-126, 132-136, 142-146 specific to each of states 1-N (120, 130. 140). Accordingly, it is preferable to adopt a file naming convention for the section template files that identifies the corresponding contract section and state. For example, a naming convention, such as Section_Name_SS#_V#.file, may be employed; where Section_Name refers to the name identifying a particular contract section, SS# refers to a state-specific number identifying each state, and V# refers to the version number of that section template file.

The simplified model takes advantage of commonalities between sections of state-specific contracts that have been approved as compliant with state insurance regulations by the respective state departments of insurance. In accordance with the simplified model, two types of section template files may be created—baseline section template files 200 and state-specific section template files 300. A baseline section template file 200 may define the contract language for a section of an insurance contract document that is identical in at least two state-specific insurance contract documents and/or the contract language for a section of an insurance contract document that is frequently issued. For example, rather than maintaining separate state-specific section template files 300 defining identical contract language for a given section of an insurance contract document, a single baseline section template file 200 may replace the multiple state-specific section template files 300 defining identical contract language for a given section of an insurance contract document. A state-specific section template file 300 defines the contract language for a section of an insurance contract document for a specified state, which is different than the language of a baseline section template file 200 for the same section of an insurance contract document.

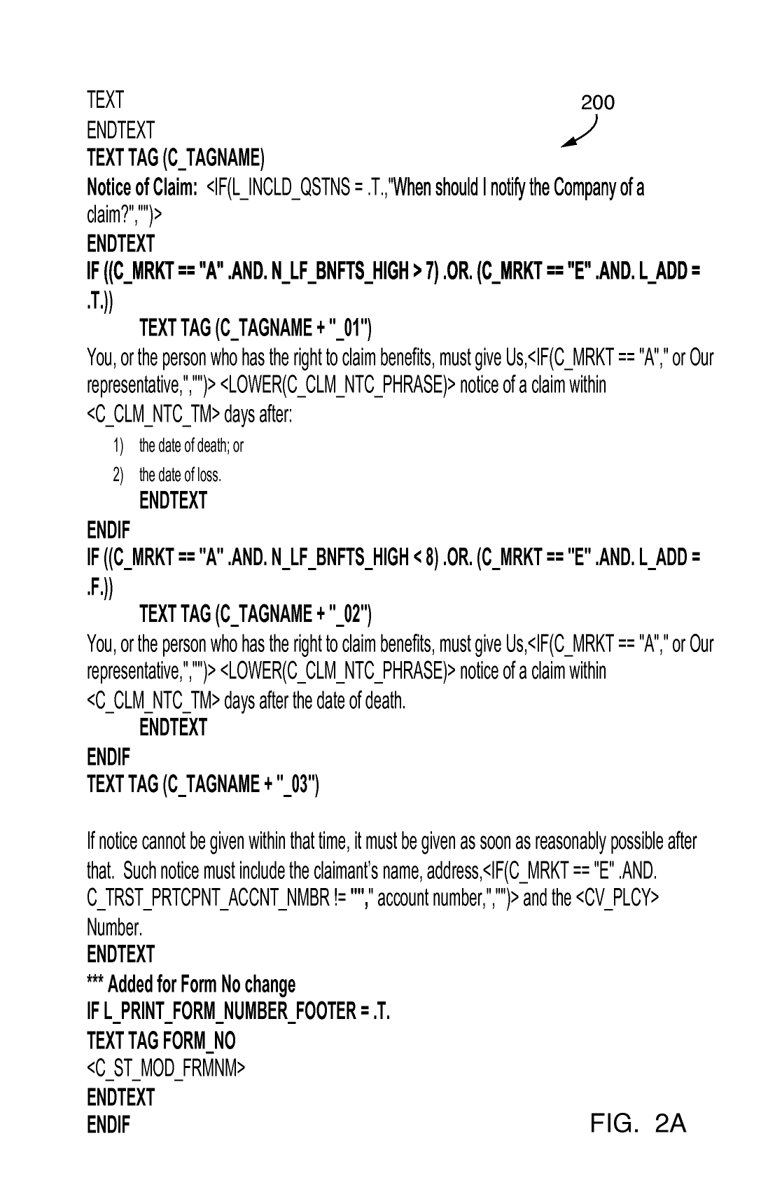

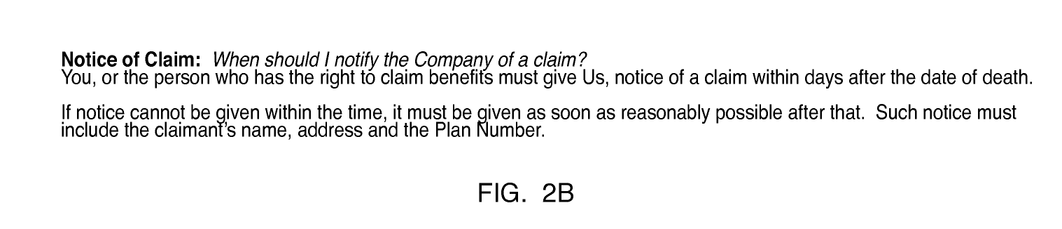

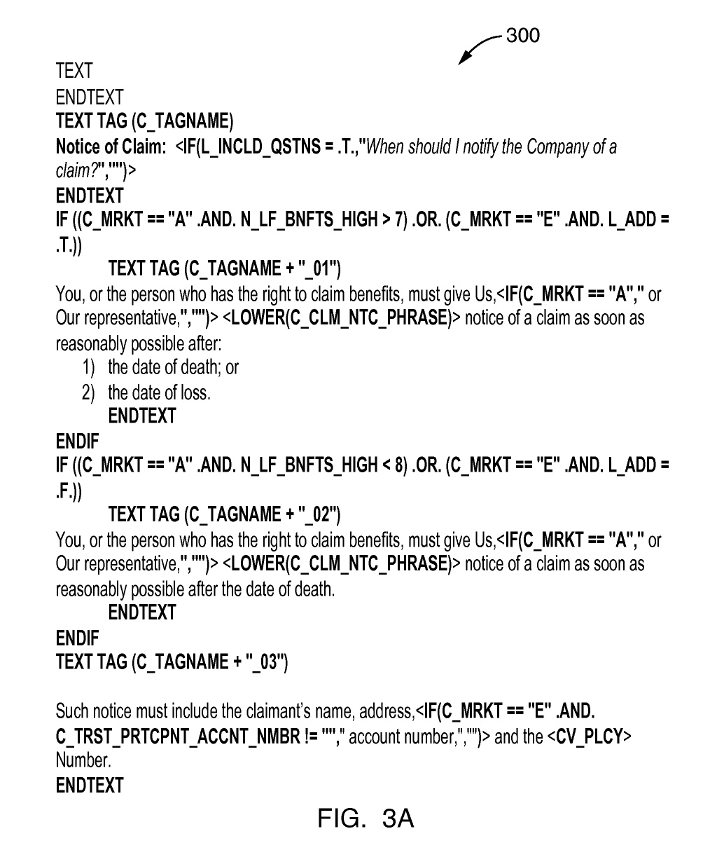

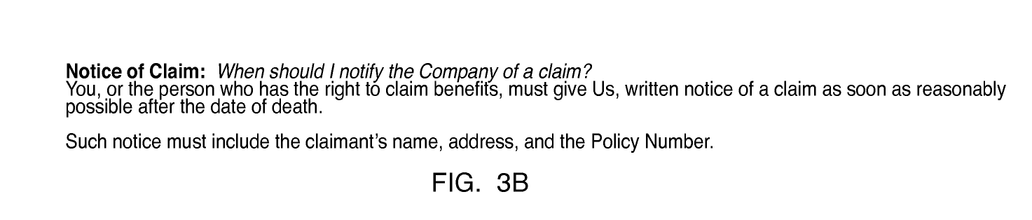

FIG. 2A shows an exemplary baseline section template file 200 for the “Notice of Claim” section of a life insurance contract document. FIG. 3A shows an Ohio-specific section template file 300 for the “Notice of Claim” section of a life insurance contract document. FIG. 2B shows the baseline contract language generated for the “Notice of Claim” section of a life insurance contract document based on the baseline section template file 200 of FIG. 2A. FIG. 3B shows the Ohio-specific contract language generated for the “Notice of Claim” section of a life insurance contract document based on the Ohio-specific section template file 300 of FIG. 3A. The baseline contract language for the “Notice of Claim” section corresponding to the baseline section template file 200 of FIGS. 2A 2B states that notice of a claim must be given within days after the date of death, and that if notice cannot be given within that time, it must be given as soon as reasonably possible after that. By contrast, the Ohio-specific contract language for the “Notice of Claim” section corresponding to the Ohio-specific section template file 300 of FIGS. 3A, 3B states that written notice of a claim must be given as soon as reasonably possible after the date of death. Otherwise, the baseline contract language and the Ohio-specific contract language for the “Notice of Claim” section is the same.

An insurance contract document may be generated for a specified insurance product, for a specified market class (e.g., employee, association), and for a specified state. Among the insurance products are group benefits insurance products such as life insurance (LIFE), long-term disability insurance (LTD), short-term disability insurance (WD) and accidental death & dismemberment insurance (ADD). Also, an insurance contract document may be generated specifically for different classes of persons: for example, employees who are part of an employer's group benefits program, or association members who are part of an association's group benefits program. Further, an insurance contract document may be generated specifically for different states having different state insurance regulations. Accordingly, a specific set of contract generation rules may be provided depending on the specified insurance product(s), market class and state to generate an insurance contract document.

Contract generation rules define the baseline section template files and state-specific section template to be used in generating an insurance contract document. Contract generation rules may be stored in a table so that specific sets of contract rules for generating an insurance contract document are identified as corresponding to a particular insurance product, a particular market class and a particular state. In a preferred embodiment, state-specific contracts are generated by defining a combination of baseline section template files and state-specific section template files based on contract generation rules adapted to generate an insurance contract document for a specified state that has been confirmed as being compliant with said specified state's insurance regulations. For example, when generating an insurance contract document corresponding to a particular insurance product and a particular market class to be issued in New York State, contract generation rules corresponding to that insurance product, market class and New York State are referenced. The contract generation rules corresponding to the insurance product, market class and New York State are adapted to define the combination of baseline section template files and New-York-specific section template files that will generate an insurance contract document that is identical to an insurance contract document that has been approved by New York's department of insurance and is confirmed to be compliant with New York State insurance regulations.

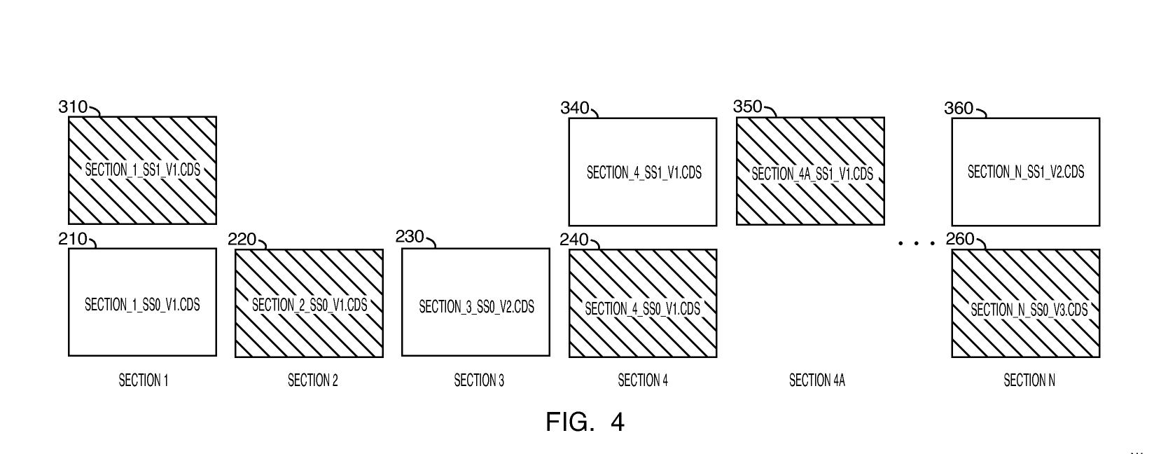

FIG. 4 illustrates the selection of a combination of baseline section template files 210, 220, 240, 260 and state specific section template files 310, 340, 350, 360 (shown by the shaded boxes) in accordance with contract generation rules for generating an insurance contract document for a specified state. As discussed above, the section template files may have a standard naming convention as shown in FIG. 4. Baseline section template files are identified by the identifier SS0 and the state-specific section template files are identified by the identifier SS1, which corresponds to a specific state. Additionally, the section of the contract to which the section template file corresponds is identified by “SECTION_#” and the version of the section template file is identified by “V#.” FIG. 4 illustrates the combination of baseline section template files and state-specific section template files (shown by the shaded boxes) defined by contract generation rules for generating an insurance contract document for a state corresponding to identifier SS1. As shown in FIG. 4, in order to generate an insurance contract document for the state corresponding to identifier SS1, the state-specific section template file for SECTION_1, the baseline section template file for SECTION_2, the baseline section template file for SECTION_4, the state-specific section template file for SECTION_4A and the baseline section template file for SECTION_N must be combined. Accordingly, a state-specific insurance contract document for the state corresponding to identifier SS1 is generated, which is confirmed to be compliant with the insurance regulations of the state corresponding to identifier SS1.

As illustrated in FIG. 4, contract generation rules may define that neither a baseline or state-specific section template file is to be used in generating a particular insurance contract document. For example, as illustrated in FIG. 4, no section template file is selected for Section 3 in generating the insurance contract document for a state corresponding to identifier SS1. In other words, for certain insurance contract documents, the contract generation rules may define that one or more contract sections may be omitted. Also, as illustrated in FIG. 4, contract generation rules may define that a state-specific section template file without a corresponding baseline section template file is to be used in generating a particular insurance contract document. For example, as illustrated in FIG. 4, there is a state-specific section template file 350 corresponding to Section 4A, but there is no baseline section template file for Section 4A. In this example, the state-specific insurance contract document being generated requires a Section 4A, which is not part of the baseline section template files. Accordingly, for certain insurance contract documents, the contract generation rules may define that one or more contract sections may be added.

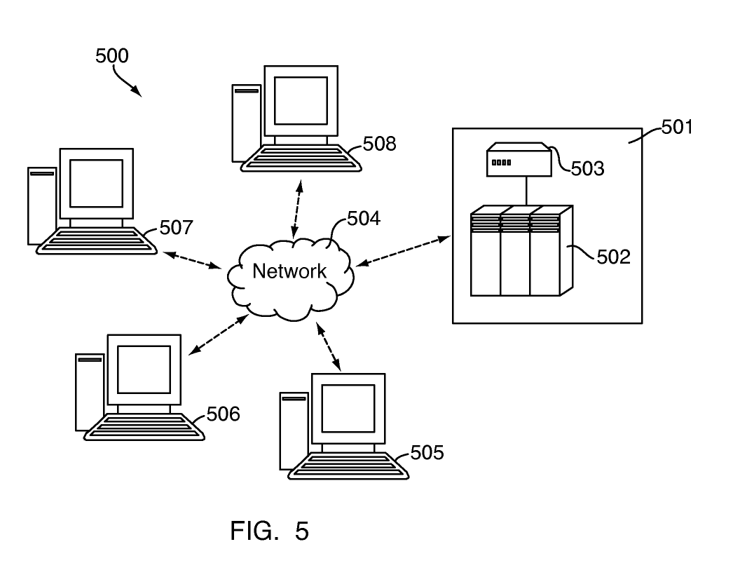

The simplified model presented for maintaining and creating insurance contract documents provides certain advantages. For instance, the simplified model presented allows for creation of state-specific insurance contract documents on demand, which are confirmed to be compliant with the most up-to-date state insurance regulations. Also, the simplified model presented obviates the need for maintaining separate state-specific insurance contract documents or insurance contract documents implementing conditional logic to comply with various states' insurance regulations. As a result, changes to contract provisions of a state-specific contract can be implemented more easily by revising existing state-specific section template files and/or by creating new state-specific section template files. The simplified model described above is implemented in the various embodiments of the systems and methods described in more detail below with reference to FIGS. 5-14.

FIG. 5 is a block diagram of an insurance computer network 500, according to an illustrative embodiment of the invention. The insurance computer network 500 includes one or more insurance companies 501 with an insurance company computer system 502 and a web server 503. The insurance company 501, its computer system 502, and/or its web server 503 are linked, via network 504, to one or more insurance company agents 505, 506 and one or more insurance company compliance officers 507, 508. Web server 503 may include one or more web interface applications or server-side application code for generating a secure web based graphical user interface for communicating with insurance company agents 505, 506 and insurance company compliance officers 507, 508. Insurance company agents 505, 506 and insurance company compliance officers 507, 508 communicate with the insurance company computer system 502 via any suitable device that is capable of communication with the secure web based graphical user interface, such as a Personal Computer (PC), a portable computing device such as a Personal Digital Assistant (PDA) or smart-phone type device, or any other appropriate storage and/or communication device. While web interface applications may be implemented on web server 503 in some embodiments, web interface applications may alternatively be implemented on computer system 502 in other embodiments. Thus, a secure web interface may be provided by computer system 502 without employing a separate web server 503.

The network 504 may be may be one or a combination of a Local Area Network (LAN), a Metropolitan Area Network (MAN), a Wide Area Network (WAN), a proprietary network, a Public Switched Telephone Network (PSTN), a Wireless Application Protocol (WAP) network, a BLUETOOTH® network, a wireless LAN network, and/or an Internet Protocol (IP) network such as the Internet, an intranet, or an extranet. Note that any devices described herein may communicate via one or more such communication networks. In some embodiments, different networks are used to link different components of the insurance computer network 500 together. For example, the systems associated with the insurance company 501, such as the insurance company computer system 502 and the web server 503 may be linked to each other via a private data network. In these embodiments, the insurance company 501 and/or one or more of its components are then linked to external systems and components via a public network such as the Internet or a PSTN. For example, when an insurance company agent 505, 506 accesses a webpage served by the web server 503 on the public network 504, the web server 503 may also retrieve and/or transmit data to the insurance company computer system 502 via the private data network. In other embodiments, the web server 503 may not be part of the insurance company 501. Instead, the web server 503 may be operated by third parties.

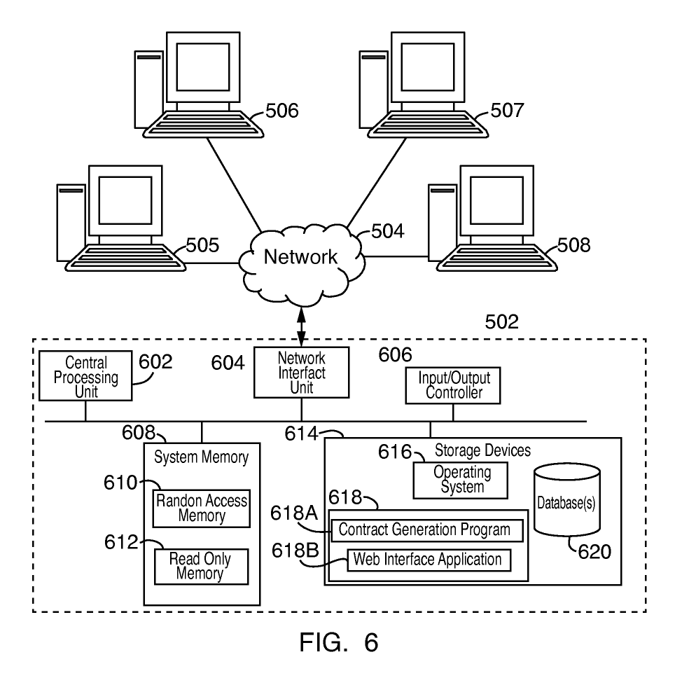

FIG. 6 is a block diagram of an exemplary embodiment of insurance company computer system 502 in the insurance company computer network 500 of FIG. 5, according to an illustrative embodiment of the invention. Insurance company computer system 502 comprises at least one central processing unit (CPU) 602, system memory 608, which includes at least one random access memory (RAM) 610 and at least one read-only memory (ROM) 612, at least one network interface unit 604, an input/output controller 606, and one or more data storage devices 614. All of these latter elements are in communication with the CPU 602 to facilitate the operation of the insurance company computer system 502. Suitable computer program code may be provided for executing numerous functions. For example, the computer program code may include program elements such as an operating system, a database management system and “device drivers” that allow the processor to interface with computer peripheral devices (e.g., a video display, a keyboard, a computer mouse, etc.) via the input/output controller 606.

The insurance company computer system 502 may be configured in many different ways. In the embodiment shown in FIG. 6, the insurance company computer system 502 is linked, via network 504 (also described in FIG. 5), to one or more insurance company agents 505 and one or more insurance company compliance officers 507. Insurance company computer system 502 may be a conventional standalone computer or alternatively, the function of computer system 502 may be distributed across multiple computing systems and architectures. In some embodiments, insurance company computer system 502 may be configured in a distributed architecture, wherein databases and processors are housed in separate units or locations. Some such units perform primary processing functions and contain at a minimum, a general controller or a processor 602 and a system memory 608. In such an embodiment, each of these units is attached via the network interface unit 604 to a communications hub or port (not shown) that serves as a primary communication link with other servers, client or user computers and other related devices. The communications hub or port may have minimal processing capability itself, serving primarily as a communications router. A variety of communications protocols may be part of the system, including but not limited to: Ethernet, SAP®, SAS®, ATP, BLUETOOTH®, GSM and TCP/IP.

The CPU 602 comprises a processor, such as one or more conventional microprocessors and one or more supplementary co-processors such as math co-processors. The CPU 602 is in communication with the network interface unit 604 and the input/output controller 606, through which the CPU 602 communicates with other devices such as other servers, user terminals, or devices. The network interface unit 604 and/or the input/output controller 606 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The CPU 602 is also in communication with the data storage device 614. The data storage device 614 may comprise an appropriate combination of magnetic, optical and/or semiconductor memory, and may include, for example, RAM, ROM, flash drive, an optical disc such as a compact disc and/or a hard disk or drive. The CPU 602 and the data storage device 614 each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wired medium or combination of the foregoing. For example, the CPU 602 may be connected to the data storage device 614 via the network interface unit 604.

The data storage device 614 may store, for example, (i) database(s) 620 adapted to store information that may be utilized to store information required by the program; (ii) an operating system 616 for the insurance company computer system 502; and/or (iii) one or more programs 618 (e.g., computer program code and/or a computer program product) adapted to direct the CPU 602 in accordance with the present invention, and particularly in accordance with the processes described in detail with regard to the CPU 602. The CPU 602 of insurance company computer system 502 is adapted to execute one or more programs 618 stored in data storage device 614, including a Contract Generation Program 618A and a web interface application 618B.

The operating system 616 and/or programs 618 may be stored, for example, in a compressed, an uncompiled and/or an encrypted format, and may include computer program code. The instructions of the computer program code may be read into a main memory of the processor from a computer-readable medium other than the data storage device 614, such as from the ROM 612 or from the RAM 610. While execution of sequences of instructions in the program causes the processor 602 to perform the process steps described herein, hard-wired circuitry may be used in place of, or in combination with, software instructions for implementation of the processes of the present invention. Thus, embodiments of the present invention are not limited to any specific combination of hardware and software.

A program 618 may also be implemented in programmable hardware devices such as field programmable gate arrays, programmable array logic, programmable logic devices or the like. Programs 618 may also be implemented in software for execution by various types of computer processors. A program 618 of executable code may, for instance, comprise one or more physical or logical blocks of computer instructions, which may, for instance, be organized as an object, procedure, process or function. Nevertheless, the executables of an identified program 618 need not be physically located together, but may comprise separate instructions stored in different locations which, when joined logically together, comprise the program 618 and achieve the stated purpose for the programs 618 such as implementing the contract generation instructions prescribed by system 502. In the present invention an application of executable code may be a compilation of many instructions, and may even be distributed over several different code partitions or segments, among different programs, and across several devices.

The term “computer-readable medium” as used herein refers to any medium that provides or participates in providing instructions to the processor of the computing device (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the processor 602 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Database(s) 620 stores section template files defining contract language for section of insurance contract documents that have been approved for use in various States by the States' departments of insurance and by insurance company compliance officers 507, 508. Section template files for insurance contract documents may be identified and illustrated herein within programs 618, and may be embodied in any suitable form and organized within any suitable type of data structure. Such section template files for insurance contract documents may be collected as a single data set, or may be distributed over different locations including over different storage devices, and may exist, at least partially, merely as electronic signals on a system and/or network as shown and describe herein. Database(s) 620 may include a database management system (DBMS) software of a relational database type, such as a DB2 UNIVERSAL DATABASE™ provided by International Business Machines Corporation, an Access™ product provided by Microsoft Corporation or an Oracle® Database product provided by Oracle Corporation for storing and processing information related to workers compensation related complaint information in the present invention. In some embodiments, database(s) 620 may also provide certain database query functions such as generation of structured query language (SQL) in real time to access and manipulate the data.

Database(s) 620 stores section template files defining contract language for sections of insurance contract documents that have been approved by their respective state's department of insurance. In order to prevent inadvertent and/or unapproved changes to provisions in an insurance contract document, the section template files are preferably read-only type files. Two types of section template files may be stored—baseline section template files 200 and state-specific section template files 300. A baseline section template file 200 may define the contract language for a section of an insurance contract document that is identical in at least two state-specific insurance contract documents and/or may define the contract language for a section of an insurance contract document that is frequently issued. For example, rather than maintaining separate state-specific section template files 300 defining identical contract language for a given section of an insurance contract document, a single baseline section template file 200 may replace the multiple state-specific section template files 300 defining identical contract language for a given section of an insurance contract document. Also, if a large percentage of insurance contract documents are issued in a particular state, it may be preferable to have that particular state's contract language become the baseline section template files. Alternatively, the contract language to be implemented in the baseline section template files may be arbitrarily selected. A state-specific section template file 300 defines the contract language for a section of an insurance contract document for a specified state, which is different than the language of a baseline section template file 200 for the same section of an insurance contract document. FIG. 2 shows an exemplary baseline section template file 200 for a section of an insurance contract document, and FIG. 3 shows a state-specific section template file 300 for the same section of an insurance contract document. Also, database(s) 620 may store organizational templates, which define model contract organization of contract sections corresponding to insurance contract documents for various insurance products. Further, database(s) 620 may store baseline contracts, each of which comprises an arrangement of baseline section template files that defines an insurance contract document that is compliant in at least one state.

The Contract Generation program 618A comprises contract generation rules that define a combination of baseline section template files and state specific section template file for generating an insurance contract document that is compliant in a specified state. In one embodiment, Contract Generation program 618A may use an organizational template in conjunction with contract generation rules to organize a combination of baseline section template files and state-specific section template files into an insurance contract document that complies with a specified state's insurance regulations. In another embodiment, Contract Generation program 618A may generate an insurance contract document for a specified state by modifying a baseline contract to replace certain baseline section template files with state-specific section template files in accordance with contract generation rules said specified state. The contract generation rules of Contract Generation program 618A are adapted to define a combination of baseline section template files and/or state-specific section template files for generating an insurance contract document that is identical to an insurance contract document that has been approved by a specified state's department of insurance.

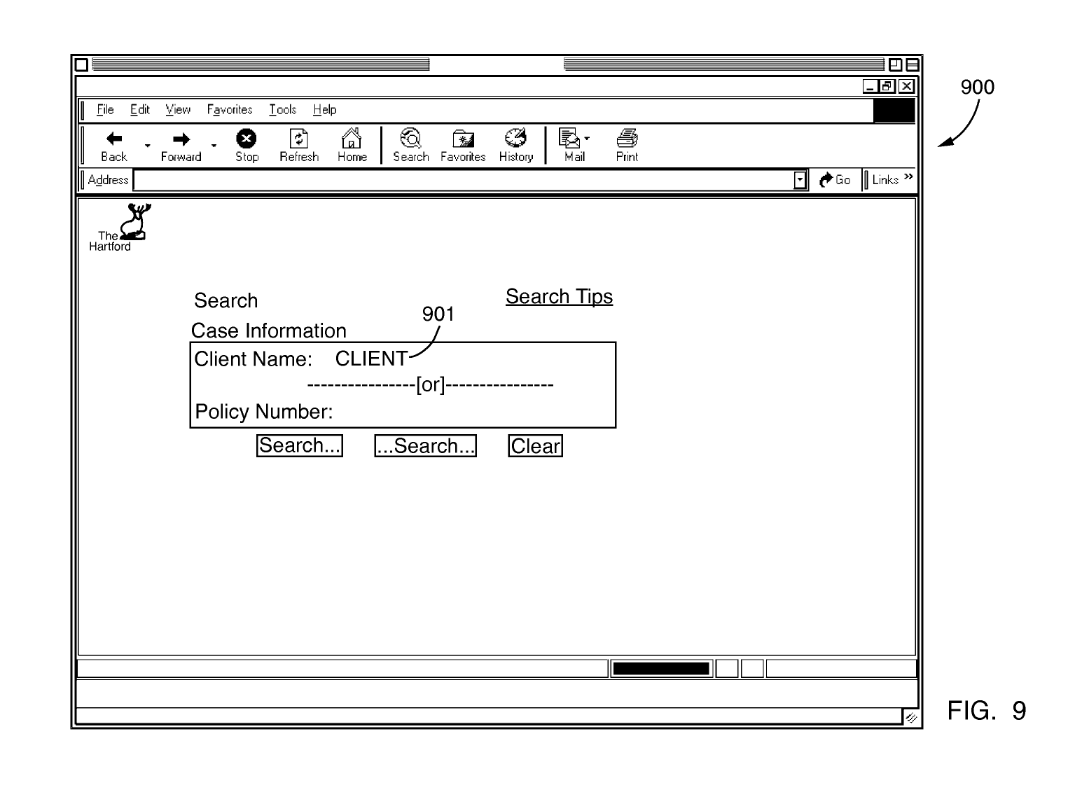

Web interface application 618B may be executed by CPU 602 to generate a secure web based graphical user interface for communicating with insurance company agents 505, 506 and insurance company compliance officers 507, 508. As shown in FIGS. 9-20, the secure web based graphical user interface may be adapted to receive information regarding the insurance contract document to be generated. For example, the information may include name, insurance product, etc. Further, generated insurance contract documents may be transmitted and presented via the secure web-based graphical user interface.

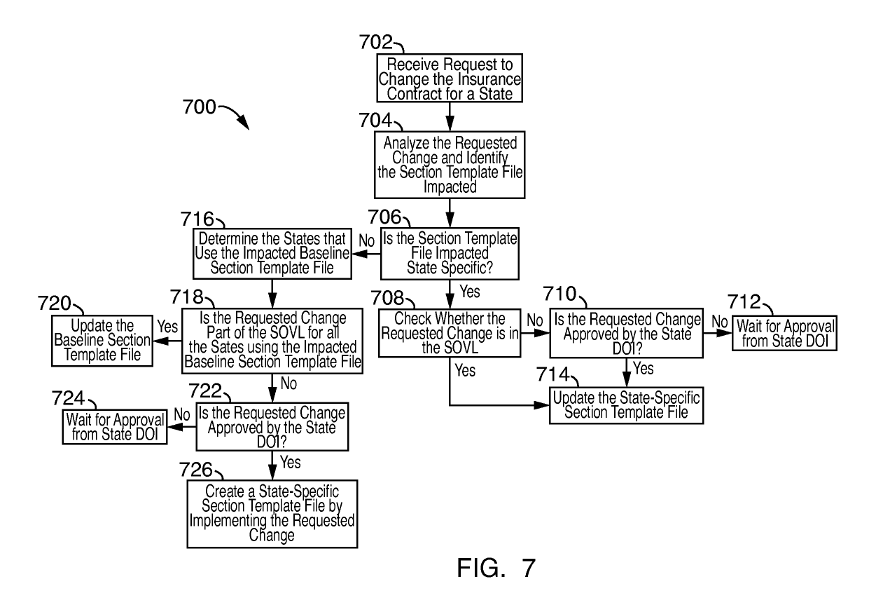

Referring to FIG. 7, the CPU 602 of insurance company computer system 502 executes a program for a computerized method 700 for amending insurance contract documents while maintaining compliance with state insurance regulations. The method 700 includes a step 702 of receiving a request to make a change to an insurance contract document for a particular state. At a step 704, the requested change is analyzed to identify the section template files that are affected by the requested change. At a step 706, it is determined whether an affected section template file is a baseline section template file or a state-specific section template file. Additionally, in conjunction with either step 704 or 706, it may be determined whether a change to the affected section template file will impact other section template files. Such a determination may be accomplished by, for example, referencing a table that defines related section template files. This ensures that a change to one section of a contract does not create unintended consequences in other sections of the contract.

If at step 706 it is determined that the affected section template file is state specific, then the process 700 proceeds to a step 708. At step 708, a communication is sent to the compliance department for the insurance company to check whether the requested change is in the Statement of Variable Language (SOVL) for the insurance contract document approved for the particular state. If at step 708 it is determined that the requested change is in the SOVL, then process 700 proceeds to a step 714 where the state-specific section template file is updated to implement the requested change. However, if at step 708 it is determined that the requested change is not in the SOVL, then process 700 proceeds to a step 710. At step 710, it is determined whether the requested change has been approved by the particular state's department of insurance (DOI). If at step 710 it is determined that the requested change has been approved by the particular state's DOI, then process 700 proceeds to a step 714 where the state-specific section template file is updated to implement the requested change. However, if at step 710 it is determined that the requested change has not been approved by the particular state's DOI, then process 700 proceeds to a step 712 to wait for approval of the requested change from the particular state's DOI.

Referring back to step 706, if it is determined that a section template file affected by the requested change is not state specific, i.e., is a baseline section template file, then process 700 proceeds to a step 716. At step 716, it is determined which states use the baseline section template file affected by the requested change. At a step 718, it is determined whether the requested change is part of the Statement of Variable Language (SOVL) of all of the states' insurance contract documents using the affected baseline section template file. If at step 718 it is determined that the requested change is part of the SOVL of all of the states' insurance contract documents using the affected baseline section template file, then process 700 proceeds to a step 720 where the baseline section template file is updated to implement the requested change. However, if at step 718 it is determined that the requested change is part of the SOVL of all of the states' insurance contract documents using the affected baseline section template file, then process 700 proceeds to a step 722. At step 722, it is determined whether the requested change has been approved for any one of the states using the affected baseline section template file. If at step 722 it is determined that the requested change is not approved by a state DOI, then process 700 proceeds to a step 724 to wait for approval of the requested change from the state's DOI. However, if at step 722 it is determined that the requested change is approved by a particular state's DOI, then process 700 proceeds to a step 726 where a state-specific section template file that implements the requested change is created for the particular state. For example, in step 726, the state-specific section template file may be created by copying the baseline section template file and modifying the baseline section template file in accordance with the requested change.

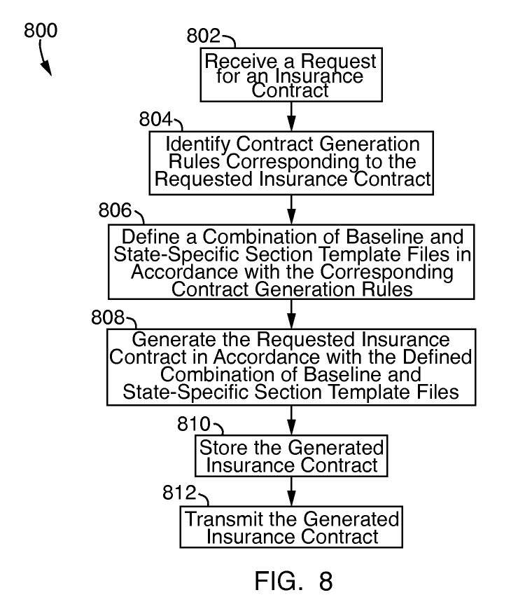

Referring to FIG. 8, the CPU 602 of insurance company computer system 502 executes a program for a computerized method of generating state-specific insurance contract documents that are compliant with their respective state's insurance regulations. Method 800 includes a step 802 of receiving a request for an insurance contract document.

At a step 804, the contract generation rules corresponding to the requested insurance contract document are identified. The contract generation rules are adapted to generate an insurance contract document that is identical to an insurance contract document that has been approved by the specified state's department of insurance.

At a step 806, a combination of baseline and state-specific section template files is defined based on the contract generation rules for the requested contract for generating an insurance contract document that is compliant in the specified state. Section template files are provided in one or more databases in accordance with the above description of the systems of the present application and the implementation of the section template files in these systems.

At a step 808, the requested insurance contract document is generated in accordance with the combination of baseline and state-specific section template files defined by the contract generation rules.

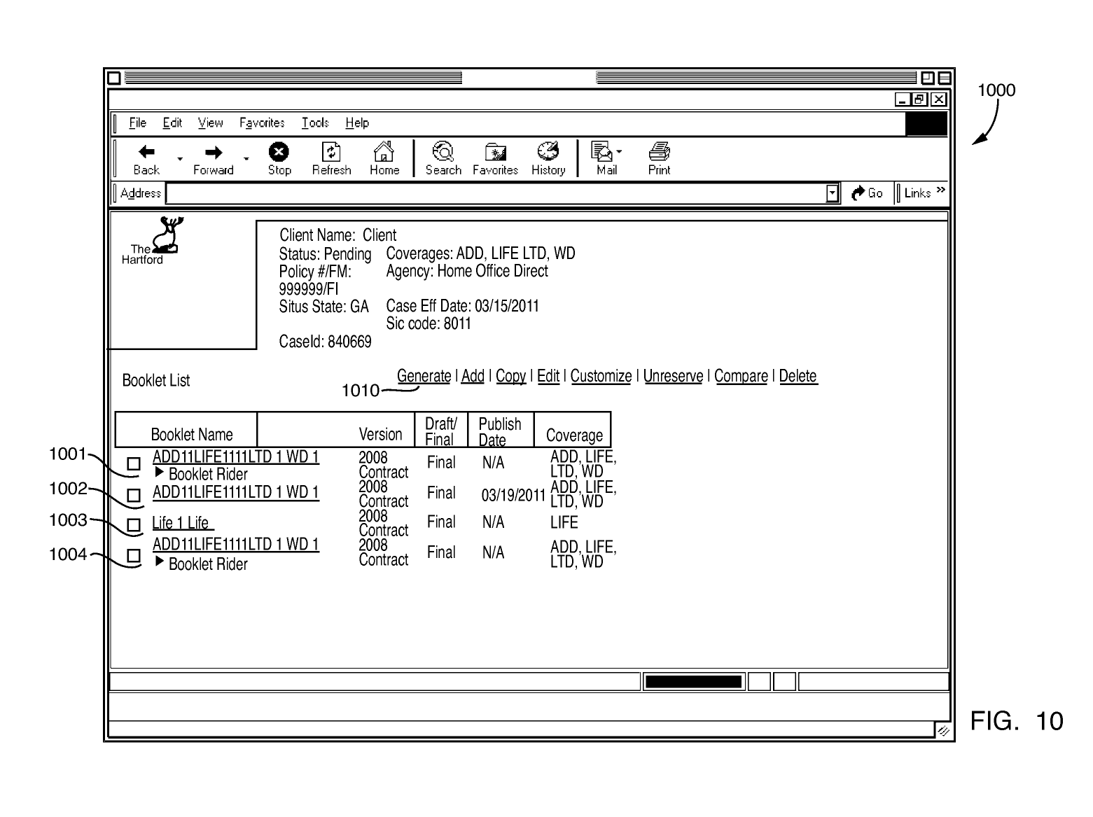

At a step 810, the generated insurance contract document is stored in insurance company computer system 502. As illustrated in FIG. 10, previously generated insurance contract documents and newly created insurance contract documents may be stored by insurance company computer system 502.

At a step 812, the generated insurance contract document is transmitted. The generated insurance contract document may be transmitted to, for example, a database of a contract management system of the insurance company, a web server where the insurance contract document may be securely accessed via a web-based graphical user interface, or a printer so that a physical copy of the insurance contract document may be delivered to the client.

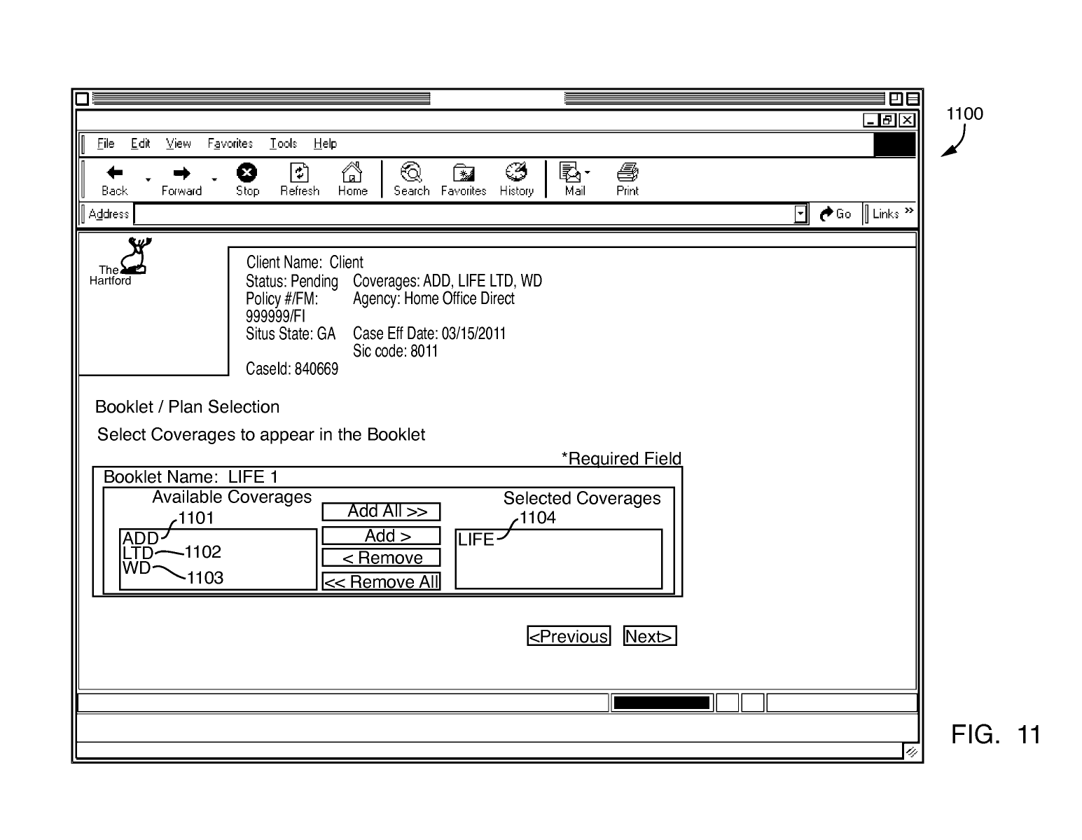

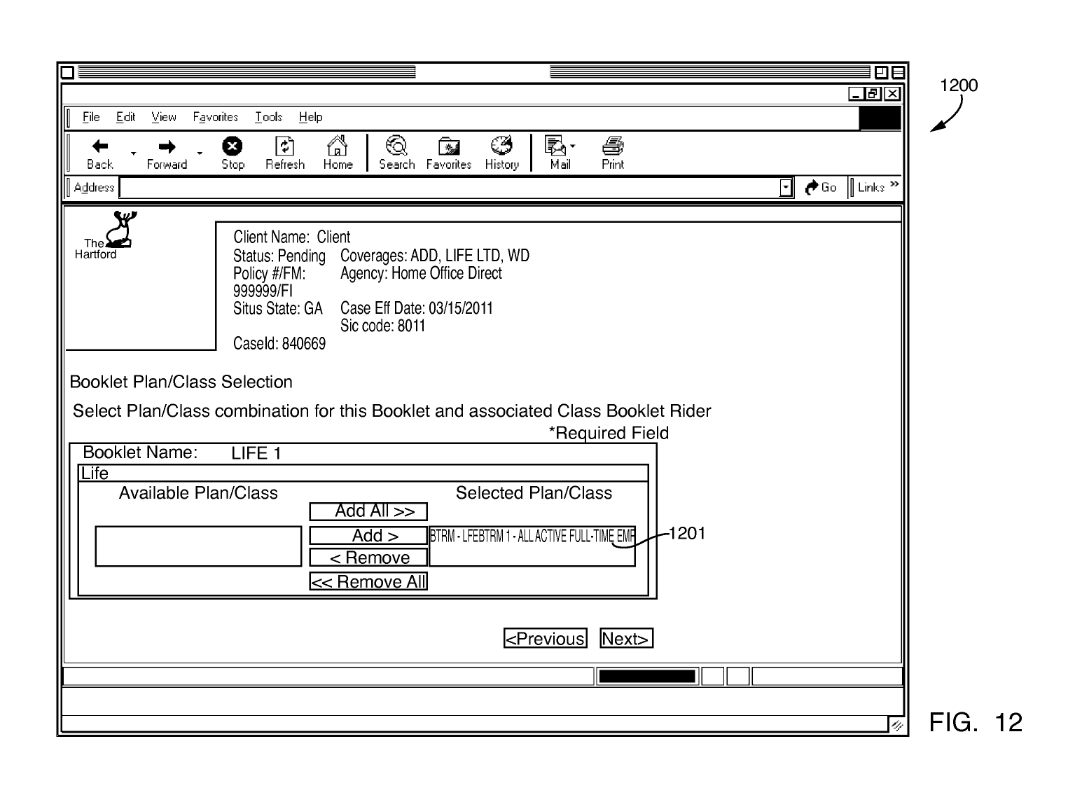

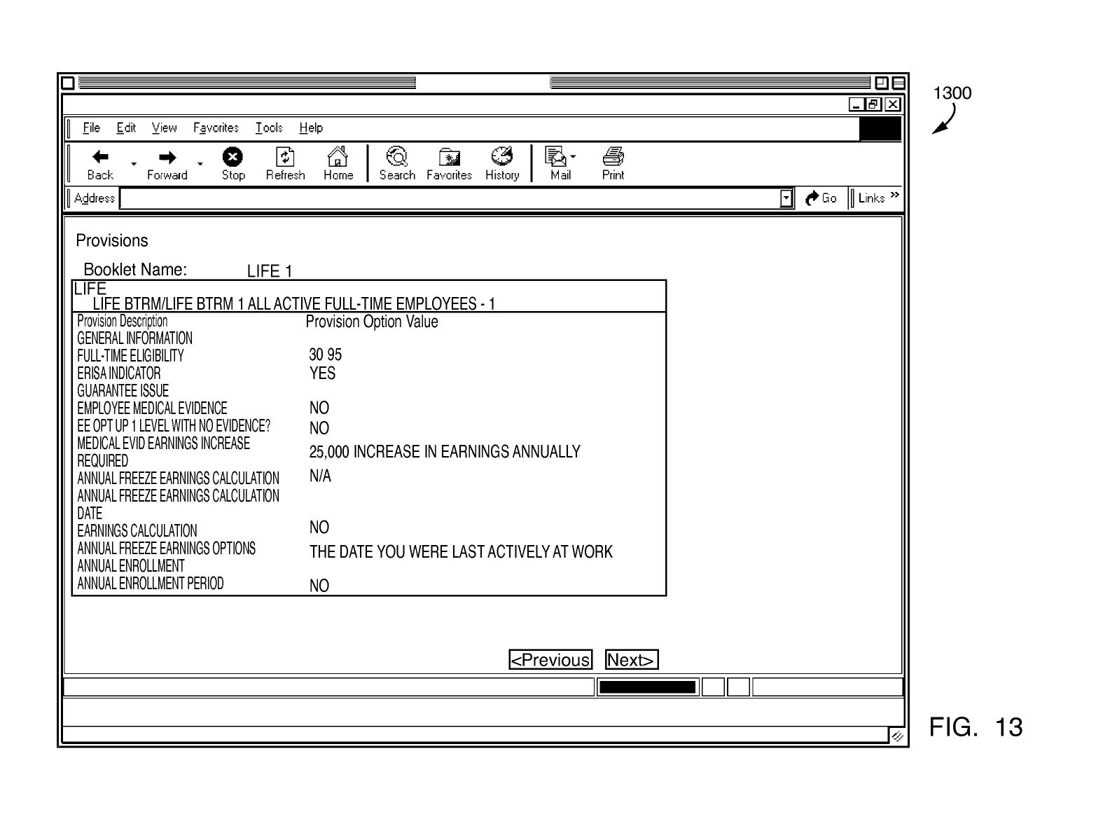

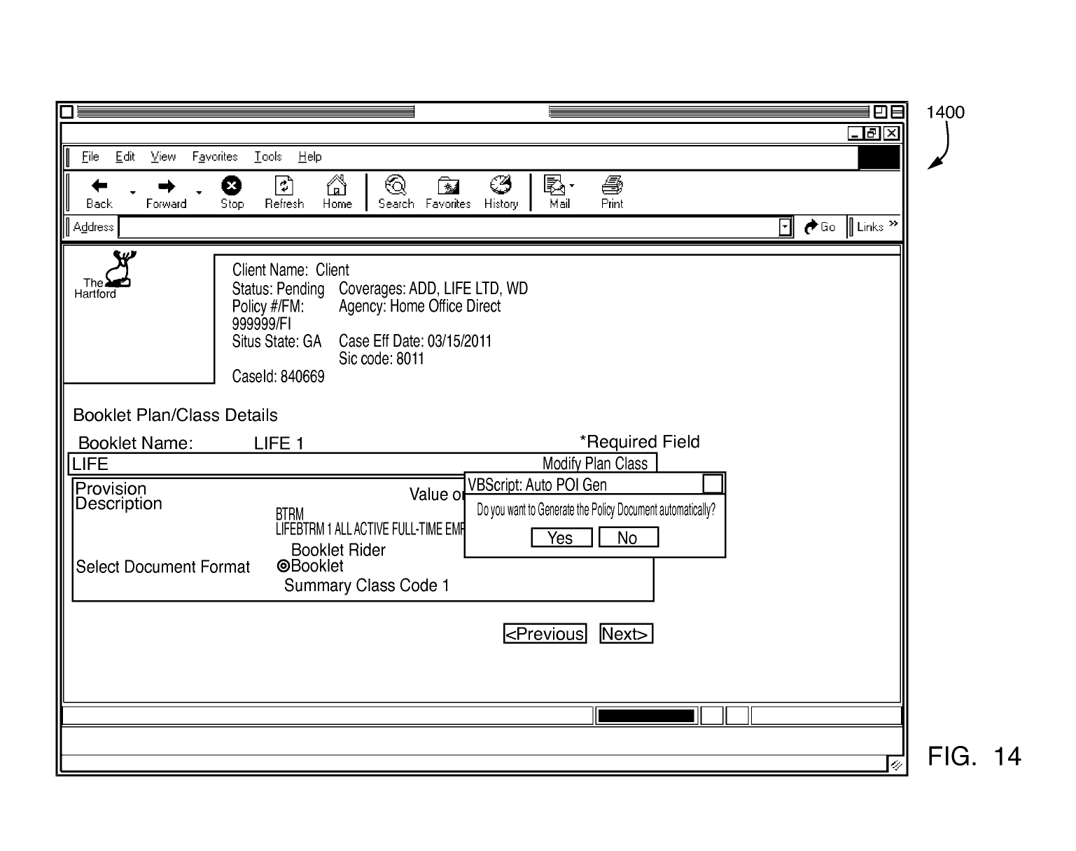

The request for the insurance contract document may be received via a web-based graphical user interface as illustrated in the embodiment of FIGS. 9-14. As shown in FIGS. 9-14, the request for an insurance contract document may include information regarding the contract to be generated, including client name, insurance products, state, etc. For example, as illustrated in FIG. 9, a web-based graphical user interface may prompt a user (e.g., insurance agent for a client name) for a client name 901. Once a client name is entered, the graphical user interface of FIG. 10 may be presented to the user to show all of the insurance contract documents 1001-1004 that have been previously generated and stored for that client. Also, in the graphical user interface of FIG. 10, an option 1010 may be provided for generating new insurance contract documents. If option 1010 is selected in the graphical user interface of FIG. 10, the graphical user interface of FIG. 11 may be presented to the user. In the graphical user interface of FIG. 11, the insurance products that are part of the client's group benefits program are presented for selection. For example, accidental death & dismemberment insurance (ADD) 1101, long-term disability insurance (LTD) 1102, short-term disability insurance (WD) 1103 and life insurance (LIFE) 1104 may be among the options that can be selected. In the graphical user interface of FIG. 12, the particular plan(s)/class(es) 1201 for the selected insurance product are presented for selection. In the graphical user interface of FIG. 13, the user can set the terms of the insurance policy purchased by the client in order to generate the appropriate insurance contract document. As shown in the graphical user interface of FIG. 14, once all of the information for generating an insurance contract document has been input by the user, the user can elect to generate the insurance contract document.

Although this invention has been shown and described with respect to detailed embodiments thereof, it will be understood by those skilled in the art that various changes in form and detail thereof may be made without departing from the spirit and the scope of the invention. With respect to the embodiments of the systems described herein, it will be understood by those skilled in the art that one or more system components may be added, omitted or modified without departing from the spirit and the scope of the invention. With respect to the embodiments of the methods described herein, it will be understood by those skilled in the art that one or more steps may be omitted, modified or performed in a different order and that additional steps may be added without departing from the spirit and the scope of the invention.

1. A system for generating state-specific insurance contract documents for an employer's or association's group benefits program, comprising:
a data storage device comprising a database and a contract generation program for generating an insurance contract document corresponding to a specified insurance product, market class and state;
the database storing baseline section template files corresponding to more than one state and state-specific section template files corresponding to a single state, each of the baseline section template files and state-specific section template files corresponding to a specific section of an insurance contract document that is compliant with corresponding state insurance regulations, wherein a baseline section template file and state-specific section template file(s) corresponding to the same contract section are different; and
at least one processor connected to said data storage device for executing said contract generation program to generate an insurance contract document for said specified insurance product, market class and state by defining a combination of baseline section template files and state-specific section template files that has previously been determined to comply with said specified state's insurance regulations.

2. The system according to claim 1, said data storage device further comprising a web interface application, which is executed by said at least one processor to generate a secure web-based graphical user interface.

3. The system according to claim 2, wherein said secure web-based graphical user interface is adapted to prompt for information regarding an insurance contract document to be generated, including said specified state.

4. The system according to claim 3, wherein said information regarding the insurance contract document to be generated is used by said contract generation program to generate said insurance contract document for said specified state.

5. The system according to claim 2, wherein said at least one processor also transmits said generated insurance contract document via said secure web-based graphical user interface.

6. The system according to claim 1, wherein said contract generation program includes contract generation rules for generating an insurance contract document for a specified state that has been confirmed as being compliant with said specified state's insurance regulations.

7. A computerized method for generating state-specific insurance contract documents for an employer's or association's group benefits program, comprising the steps of:
storing baseline section template files and state-specific section template files, wherein each of the baseline section template files corresponds to more than one state and each of the state-specific section template files corresponds to a single state, wherein each of the baseline section template files and state-specific section template files corresponds to a particular section of an insurance contract document that has been confirmed as compliant with a corresponding state's insurance regulations, and wherein a baseline section template file and a state-specific section template file(s) corresponding to the same contract section are different;
receiving, by a contract generation program executing on a computer processor, information regarding an insurance product, market class and state for which an insurance contract document is to be generated;
identifying, by the contract generation program executing on the computer processor, contract generation rules for generating state-specific insurance contract document for said insurance product, market class and state that is compliant with said state's insurance regulations;
defining, by the contract generation program executing on the computer processor, a combination of baseline section template files and state-specific section template files that has previously been determined to comply with said state's insurance regulations; and
generating, by the contract generation program executing on the computer processor, an insurance contract document in accordance with the combination of baseline section template files and state-specific section template files defined by the contract generation program executing on the computer processor.

8. The method according to claim 7, wherein said information regarding the insurance product, market class and state for which the insurance contract document is to be generated is received via a secure web-based graphical user interface.

9. The method according to claim 7, further comprising a step of transmitting the generated insurance contract document via a secure web-based graphical user interface.

10. The method according to claim 7, wherein the step of defining combination of baseline section template files and state-specific section template files is based on contract generation rules for generating an insurance contract document for said state that has been confirmed as being compliant with said state's insurance regulations.

11. (canceled)

12. The method according to claim 11, further comprising a step of storing organizational templates corresponding to insurance contract documents for various insurance products and market classes, said organizational templates defining sections of an insurance contract document for a particular insurance product and market class; and
wherein the step of generating an insurance contract document includes organizing the baseline section template files and state-specific section template files based on an organizational template corresponding to the insurance product for which the insurance contract document is to be generated.

13. The method according to claim 11, further comprising a step of
storing baseline insurance contract documents corresponding to various insurance products and market classes, said baseline insurance contract documents being defined by baseline section template files; and
wherein the step of generating the insurance contract document includes replacing a baseline section template file, in a baseline insurance contract document corresponding to the insurance product for which the insurance contract document is to be generated, with a state-specific section template file in accordance with the combination of baseline section template files and state-specific section template files defined by the contract generation program executing on the computer processor.

14. A non-transitory, tangible computer-readable medium storing instructions adapted to be executed by a computer processor to perform a method for generating state-specific insurance contract documents for an employer's or association's group benefits program, said method comprising the steps of:
storing baseline section template files and state-specific section template files, wherein each of the baseline section template files corresponds to more than one state and each of the state-specific section template files corresponds to a single state, wherein each of the baseline section template files and state-specific section template files corresponds to a particular section of an insurance contract document that has been confirmed as compliant with a corresponding state's insurance regulations, and wherein a baseline section template file and a state-specific section template file(s) corresponding to the same contract section are different;
receiving, by a contract generation program executing on the computer processor, information regarding an insurance product, market class and state for which an insurance contract document is to be generated;
identifying, by the contract generation program executing on the computer processor, contract generation rules for generating state-specific insurance contract document for said insurance product, market class and state that is compliant with said state's insurance regulations;
defining, by the contract generation program executing on the computer processor, a combination of baseline section template files and state-specific section template files that has previously been determined to comply with said state's insurance regulations; and
generating, by the contract generation program executing on the computer processor, an insurance contract document in accordance with the combination of baseline section template files and state-specific section template files defined by the contract generation program executing on the computer processor.

15. The non-transitory, tangible computer-readable medium of claim 14, wherein said information regarding the insurance product, market class and state for which the insurance contract document is to be generated is received via a secure web-based graphical user interface.

16. The non-transitory, tangible computer-readable medium of claim 14, wherein the method further comprises a step of transmitting the generated insurance contract document via a secure web-based graphical user interface.

17. The non-transitory, tangible computer-readable medium of claim 14, wherein the step of defining the combination of baseline section template files and state-specific section template files is based on contract generation rules for generating an insurance contract document for said state that has been confirmed as being compliant with said state's insurance regulations.

18. (canceled)

19. The non-transitory, tangible computer-readable medium of claim 18, wherein the method further comprises a step of
storing organizational templates corresponding to insurance contract documents for various insurance products and market classes, said organizational templates defining sections of an insurance contract document for a particular insurance product and market class; and
wherein the step of defining the combination of baseline section template files and state-specific section template files includes organizing the baseline section template files and state-specific section template files based on an organizational template corresponding to the insurance product and market class for which the insurance contract document is to be generated.

20. The non-transitory, tangible computer-readable medium of claim 18, wherein the method further comprises a step of
storing baseline insurance contract documents corresponding to various insurance products and market classes, said baseline insurance contract documents being defined by baseline section template files; and
wherein the step of generating the insurance contract document includes replacing a baseline section template file, in a baseline insurance contract document corresponding to the insurance product for which the insurance contract document is to be generated, with a state-specific section template file in accordance with the combination of baseline section template files and state-specific section template files defined by the contract generation program executing on the computer processor.

21. A computerized method for amending insurance contract documents and ensuring compliance with state insurance regulations, comprising the steps of:
receiving, by a contract management program executing on a computer processor, a request to make a change to an insurance contract document;
analyzing, by the contract management program executing on the computer processor, the requested change to identify section template files that are affected by the requested change;
determining, by the contract management program executing on the computer processor, whether an affected section template file is a baseline section template file or a state-specific section template file;
if the contract management program executing on the computer processor determines that the affected section template file is a state-specific section template file, the contract management program executing on the computer processor further determining whether the requested change is in a Statement of Variable Language for the insurance contract document or the requested change is approved by a corresponding state's Department of Insurance; and
if the contract management program executing on the computer processor determines that the requested change is in a Statement of Variable Language for the insurance contract document or is approved by the corresponding state's Department of Insurance, the contract management program executing on the computer processor updating the state-specific section template file to implement the requested changer
wherein the baseline section template files correspond to more than one state and state-specific section template files correspond to a single state, each of the baseline section template files and state-specific section template files corresponding to a specific section of an insurance contract document that is compliant with corresponding state insurance regulations, wherein a baseline section template file and a state-specific section template file(s) corresponding to the same contract section are different.

22. The method according to claim 21, wherein if the contract management program executing on the computer processor determines that the requested change is not in a Statement of Variable Language for the insurance contract document or is approved by the corresponding state's Department of Insurance, the contract management program waits for confirmation that the requested change is approved by the corresponding state's Department of Insurance.

23. The method according to claim 21, wherein if the contract management program executing on the computer processor determines that the affected section template file is a baseline section template file, the contract management program executing on the computer processor further determines the states whose contracts use the affected baseline section template file.

24. The method according to claim 23 further comprising,
determining, by the contract management program executing on the computer processor, whether the requested change to the affected baseline section template file is included in a Statement of Variable Language for each of the states whose contracts use the affected baseline section template file.

25. The method according to claim 24, wherein if the contract management program executing on the computer processor determines that the requested change is in a Statement of Variable Language for each of the states whose contracts use the affected baseline section template file, the contract management program executing on the computer processor updating the affected baseline section template file to implement the requested change.

26. The method according to claim 24, wherein if the contract management program executing on the computer processor determines that the requested change is not in a Statement of Variable Language for each of the states whose contracts use the affected baseline section template file, the contract management program executing on the computer processor further determining whether the requested change is approved by a state's Department of Insurance.

27. The method according to claim 26, wherein if the contract management program executing on the computer processor determines that the requested change is not approved by the state's Department of insurance, the contract management program waits for confirmation that the requested change is approved by the state's Department of Insurance.

28. The method according to claim 26, wherein if the contract management program executing on the computer processor determines that the requested change is approved by the state's Department of insurance, the contract management program creates a state-specific section template file for the state by implementing the requested change.

29. The method according to claim 21 further comprising,
determining whether the requested change impacts section templates files other than the affected section template file.

30. The method according to claim 21, wherein determining whether the requested change impacts section templates files other than the affected section template file, includes referencing a table that defines related section template files.
